(19) United States
(12) Patent Application Publication
(10) Pub. No.: US 2025/0149831 A1
(43) Pub. Date: May 8, 2025

(54) STRUCTURE OF SIGNAL CONNECTOR

(71) Applicant: V-General Technology Co., Ltd., New Taipei City (TW)

(72) Inventors: Po-Wen YEH, New Taipei City (TW); Tzu-Wei YEH, New Taipei City (TW); Yu-Lun YEH, New Taipei City (TW)

(21) Appl. No.: 18/931,086

(22) Filed: Oct. 30, 2024

(30) Foreign Application Priority Data
Nov. 3, 2023 (TW) 112142506

(51) Int. Cl. H01R 13/6471; H01R 12/70; H01R 12/72

(52) U.S. Cl. CPC H01R 13/6471; H01R 12/707; H01R 12/722

(57) ABSTRACT

A signal connection includes an upper-row transmission conductor group, an upper-row first high-frequency transmission conductor group, an upper-row first high-frequency transmission conductor group bend portion, an upper-row first high-frequency transmission conductor group soldering portion, an upper-row central grounding transmission conductor, an upper-row central grounding transmission conductor bend portion, an upper-row central grounding transmission conductor soldering portion, an upper-row second high-frequency transmission conductor group, an upper-row second high-frequency transmission conductor group bend portion, an upper-row second high-frequency transmission conductor group soldering portion, a lower-row transmission conductor group, a lower-row first signal transmission conductor, a lower-row first signal transmission conductor soldering portion, a lower-row power transmission conductor, a lower-row power transmission conductor soldering portion, a lower-row second signal transmission conductor, a lower-row second signal transmission conductor soldering portion, a lower-row grounding transmission conductor, and a lower-row grounding transmission conductor soldering portion, and helps enhance high-frequency signal quality and makes manufacturing easy.

### BACKGROUND OF THE INVENTION

### (a) Technical Field of the Invention

The present invention relates generally to a structure of a signal connector that helps improve the quality of high-frequency signals and is easy to manufacture.

### (b) Description of the Prior Art

The Universal Serial Bus (USB) interface, as a standard input/output interface, has been widely used in the designs of a variety of electronic devices. In 1994, Seven world-famous computer and communications companies, including Intel, Compaq, Digital, IBM, Microsoft, NEC, and Northern Telecom, jointly established the USB Association (USB-IF) and initially set up the USB interface specification, making it widely recognized by personal computer (PC) manufacturers. The interface has gradually become a required interface for hardware manufacturers.

Taking scanners, printers, and meal ordering machines as examples, USB Type-B connectors are often used for transmission of signals. However, technology is changing with each passing day and the amount of information required is continuously increasing. Therefore, new models featuring faster transmission speeds have been emerging from USB Type-B connectors for transmitting high-frequency signals, as compared to ordinary ones.

However, the above-mentioned USB Type-B connector suffers, in practical uses thereof, the following problems and deficiencies that need to be improved:

The USB Type-B connector is more complicated in the manufacture thereof, because insertion pins for connecting with a circuit substrate are often connected in a dual in-line package (DIP), and the front and rear rows are the same so as to result in necessity of drilling operation for both the front and rear rows. This not only increases the time cost, but also generates more noise interference and causes greater feedback losses.

### SUMMARY OF THE INVENTION

The primary objective of the present invention is to provide a design of making an upper-row first high-frequency transmission conductor group soldering portion, an upper-row central grounding transmission conductor soldering portion, and an upper-row second high-frequency transmission conductor group soldering portion in a surface-mount technology (SMT) form to allow the high-frequency characteristic impedance to be symmetrical and matched, thereby reducing noise interference and having lower feedback losses and making the manufacturing process more convenient.

The primary structure that the present invention adopts to achieve the aforementioned primary objective comprises an upper-row transmission conductor group and a lower-row transmission conductor group arranged below the upper-row transmission conductor group, wherein the upper-row transmission conductor group comprises an upper-row first high-frequency transmission conductor group, an upper-row first high-frequency transmission conductor group bend portion, an upper-row first high-frequency transmission conductor group soldering portion, an upper-row central grounding transmission conductor, an upper-row central grounding transmission conductor bend portion, an upper-row central grounding transmission conductor soldering portion, an upper-row second high-frequency transmission conductor group, an upper-row second high-frequency transmission conductor group bend portion, and an upper-row second high-frequency transmission conductor group soldering portion, and the lower-row transmission conductor group comprises a lower-row first signal transmission conductor, a lower-row first signal transmission conductor soldering portion, a lower-row power transmission conductor, a lower-row power transmission conductor soldering portion, a lower-row second signal transmission conductor, a lower-row second signal transmission conductor soldering portion, a lower-row grounding transmission conductor, and a lower-row grounding transmission conductor soldering portion, such that during transmission of signals through the upper-row first high-frequency transmission conductor group and the upper-row second high-frequency transmission conductor group, due to the surface-mount technology (SMT) arrangement of the upper-row first high-frequency transmission conductor group bend portion, the upper-row first high-frequency transmission conductor group soldering portion, the upper-row second high-frequency transmission conductor group bend portion, and the upper-row second high-frequency transmission conductor group soldering portion, so that mounting the entirety to the circuit substrate can be implemented with a simple process and there is no need to drill holes in the circuit substrate, and bettered characteristics impedance, enhanced high-frequency quality, reduced noise interference, and lowered feedback loss can be achieved.

Through the above technology, the problems that the conventional USB Type-B connector is more complicated to manufacture due to the pins that are inserted and connected to a circuit substrate being mostly made connectable using dual in-line package (DIP), and being identical for both the front and rear rows, so as to cause necessity of implementing drilling operations on both the front and rear rows, resulting in not only an increase of the time cost, but also more noise interference and greater feedback loss can be overcome to achieve the practical progress of the above-mentioned advantages of the present invention.

### BRIEF DESCRIPTION OF THE DRAWINGS

FIG. 1 is a perspective view showing a first preferred embodiment according to the present invention.

FIG. 2 is an exploded view showing the first preferred embodiment.

FIG. 3 is a perspective view showing upper-row and lower-row transmission conductor assemblies of the first preferred embodiment according to the present invention.

FIG. 4 is a perspective view showing implementation of the first preferred embodiment according to the present invention.

FIG. 4A is a perspective view, taken from a different angle, showing implementation of the first preferred embodiment according to the present invention.

FIG. 5 is a see-through view showing a shielding housing of a second preferred embodiment according to the present invention.

FIG. 6 is a see-through view showing a shielding housing of a third preferred embodiment according to the present invention.

FIG. 7 is a see-through view showing a shielding housing of a fourth preferred embodiment according to the present invention.

FIG. 8 is a see-through view showing a shielding housing of a fifth preferred embodiment according to the present invention.

FIG. 9 is a see-through view showing a shielding housing of a sixth preferred embodiment according to the present invention.

FIG. 10 is a see-through view showing a shielding housing of a seventh preferred embodiment according to the present invention.

FIG. 11 is a perspective see-through view showing an upper-row transmission conductor group of an eighth embodiment according to the present invention.

FIG. 12 is a perspective view showing an upper-row transmission conductor group of a ninth embodiment according to the present invention.

FIG. 13 is a perspective see-through view showing an upper-row transmission conductor group of a tenth embodiment according to the present invention.

FIG. 14 is a perspective see-through view showing an upper-row transmission conductor group of an eleventh embodiment according to the present invention.

FIG. 15 is an exploded view showing a twelfth embodiment according to the present invention.

FIG. 16 is a perspective see-through view showing upper-row and lower-row transmission conductor assemblies of the twelfth preferred embodiment according to the present invention.

### DETAILED DESCRIPTION OF THE PREFERRED EMBODIMENTS

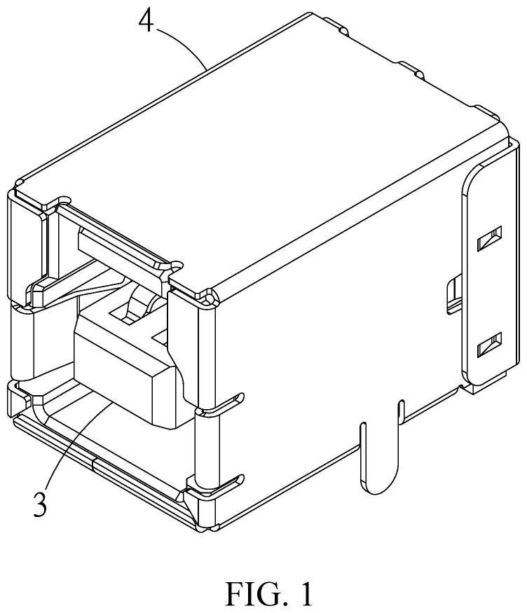

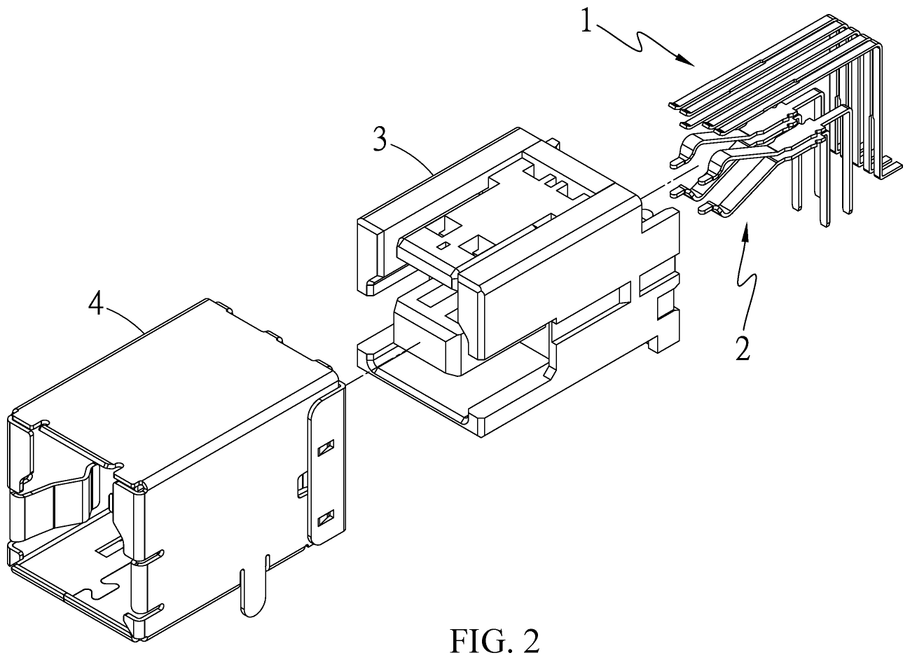

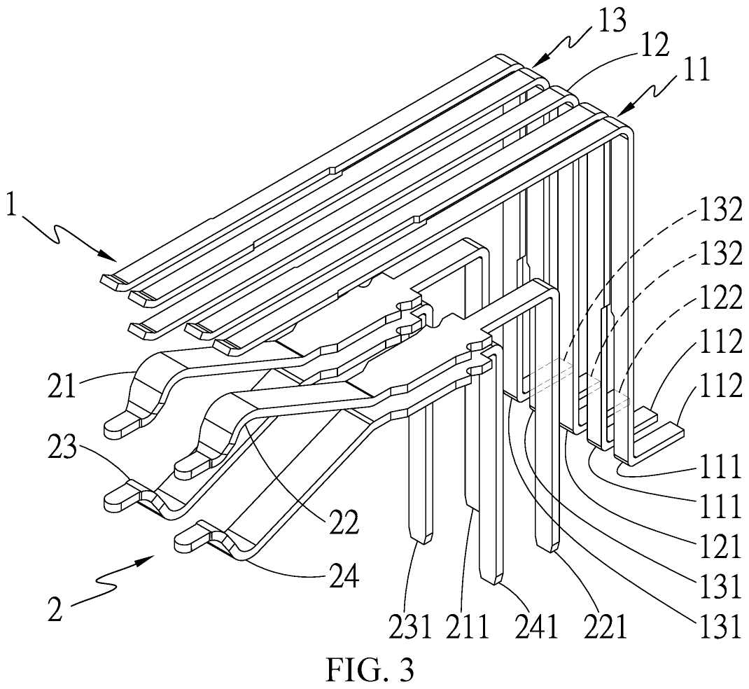

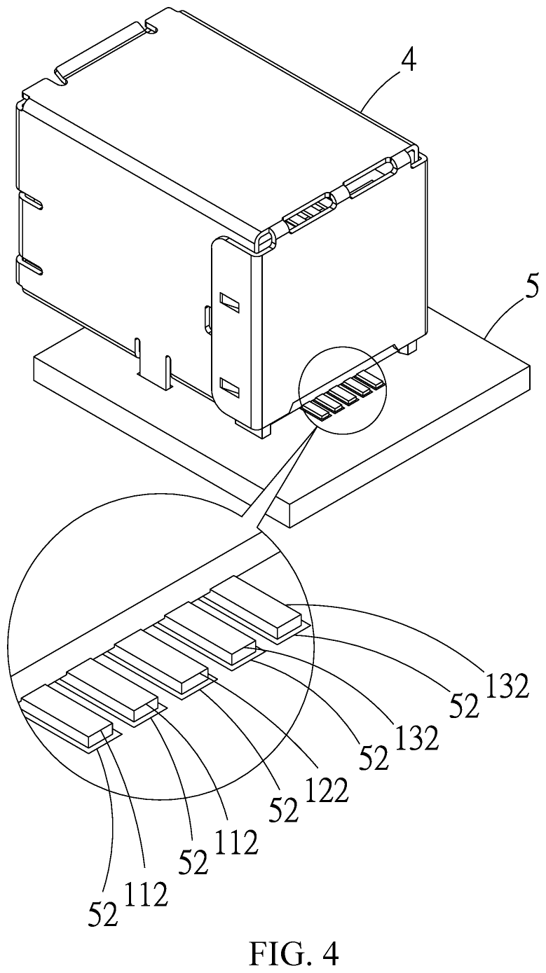

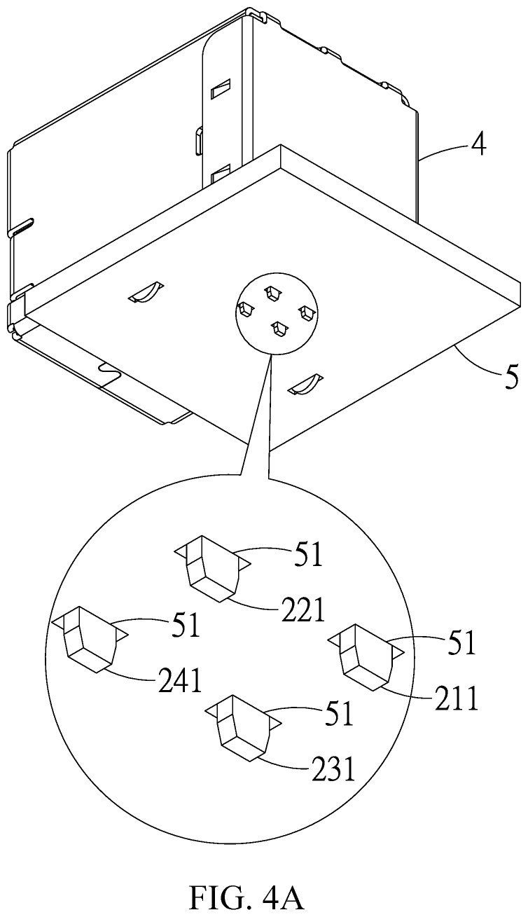

Referring to FIGS. 1-4A, which are a perspective view to a perspective view taken from another angle of implementation of a first preferred embodiment according to the present invention, it is clearly seen from the drawings that the present invention comprises:
an upper-row transmission conductor group 1, which comprises:
an upper-row first high-frequency transmission conductor group 11, which includes, at one end thereof, an upper-row first high-frequency transmission conductor group bend portion 111, the upper-row first high-frequency transmission conductor group bend portion 111 being extended to form a surface-mount technology (SMT) type upper-row first high-frequency transmission conductor group soldering portion 112;
an upper-row central grounding transmission conductor 12, which is arranged at one side of the upper-row first high-frequency transmission conductor group 11 and includes, at one end thereof, an upper-row central grounding transmission conductor bend portion 121, the upper-row central grounding transmission conductor bend portion 121 being extended to form a surface-mount technology (SMT) type upper-row central grounding transmission conductor soldering portion 122; and
an upper-row second high-frequency transmission conductor group 13, which is arranged at one side of the upper-row central grounding transmission conductor 12 opposite to the upper-row first high-frequency transmission conductor group 11 and includes, at one end thereof, an upper-row second high-frequency transmission conductor group bend portion 131, the upper-row second high-frequency transmission conductor group bend portion 131 being extended to form a surface-mount technology (SMT) type upper-row second high-frequency transmission conductor group soldering portion 132; and
a lower-row transmission conductor group 2, which is arranged below the upper-row transmission conductor group 1 and comprises:
a lower-row first signal transmission conductor 21, which includes, at one end thereof, a dual in-line package (DIP) type lower-row first signal transmission conductor soldering portion 211;
a lower-row power transmission conductor 22, which is arranged at one side of the lower-row first signal transmission conductor 21 and includes, at one end thereof, a dual in-line package (DIP) type lower-row power transmission conductor soldering portion 221;
a lower-row second signal transmission conductor 23, which is arranged below the lower-row first signal transmission conductor 21 and includes, at one end thereof, a dual in-line package (DIP) type lower-row second signal transmission conductor soldering portion 231; and
a lower-row grounding transmission conductor 24, which is arranged at one side of the lower-row second signal transmission conductor 23 and below the lower-row power transmission conductor 22 and includes, at one end thereof, a dual in-line package (DIP) lower-row grounding transmission conductor soldering portion 241.

In the above, the upper-row transmission conductor group 1 and the lower-row transmission conductor group 2 are arranged on an insulator assembly 3, and a shielding housing 4 is arranged on an outside of the insulator assembly 3.

It is clearly seen from the drawings that the present invention is mountable on a circuit substrate 5, wherein the circuit substrate 5 is formed with a plurality of through holes 51 through which the lower-row first signal transmission conductor soldering portion 211, the lower-row power transmission conductor soldering portion 221, the lower-row second signal transmission conductor soldering portion 231, and the lower-row grounding transmission conductor soldering portion 241 are arranged to extend so that the lower-row first signal transmission conductor 21, the lower-row power transmission conductor 22, the lower-row second signal transmission conductor 23, and the lower-row grounding transmission conductor 24, when put in operation for conducting, cooperate with the circuit substrate 5 to fulfill transmission of signals; further, the circuit substrate 5 is provided, on a rear side of the through holes 51, with a circuit substrate soldering portion group 52 arranged in a row, and the circuit substrate soldering portion group 52 receives the upper-row first high-frequency transmission conductor group soldering portion 112, the upper-row central grounding transmission conductor soldering portion 122, and the upper-row second high-frequency transmission conductor group soldering portion 132 to attach thereto and connect therewith through surface-mount technology (SMT) to allow signals of the upper-row first high-frequency transmission conductor group 11 to sequentially transmit through the upper-row first high-frequency transmission conductor group bend portion 111 and the upper-row first high-frequency transmission conductor group soldering portion 112 to be received by the circuit substrate 5, and signals of the upper-row second high-frequency transmission conductor group 13 sequentially transmitting through the upper-row second high-frequency transmission conductor group bend portion 131 and the upper-row second high-frequency transmission conductor group soldering portion 132 to be received by the circuit substrate 5, and signals of the upper-row central grounding transmission conductor 12 sequentially transmitting through the upper-row central grounding transmission conductor bend portion 121 and the upper-row central grounding transmission conductor soldering portion 122 to fulfill a function of grounding and also featuring isolating noises generated by the upper-row first high-frequency transmission conductor group 11 and the upper-row second high-frequency transmission conductor group 13 to make the upper-row first high-frequency transmission conductor group 11 and the upper-row second high-frequency transmission conductor group 13 not interfering with each other.

Further, with the arrangement of the upper-row first high-frequency transmission conductor group bend portion 111, the upper-row central grounding transmission conductor bend portion 121, and the upper-row second high-frequency transmission conductor group bend portion 131, the upper-row first high-frequency transmission conductor group soldering portion 112, the upper-row central grounding transmission conductor soldering portion 122, and the upper-row second high-frequency transmission conductor group soldering portion 132 are made into a surface-mount technology (SMT) form so that with surface-mount technology (SMT) form, the form that the circuit substrate soldering portion group 52 is made does not require use of the form of through holes 51 and only needs to scratch off a surface insulation layer of the circuit substrate 5, this being easier in manufacturing than through holes 51, and the solution of through holes 51 adopted in the prior art may easily cause issues of noise escape, while in the present invention, the circuit substrate soldering portion group 52 does not necessarily adopt the solution of through holes 51 so that noises may not easily escape and the issues of noise interference and feedback loss can be effectively reduced.

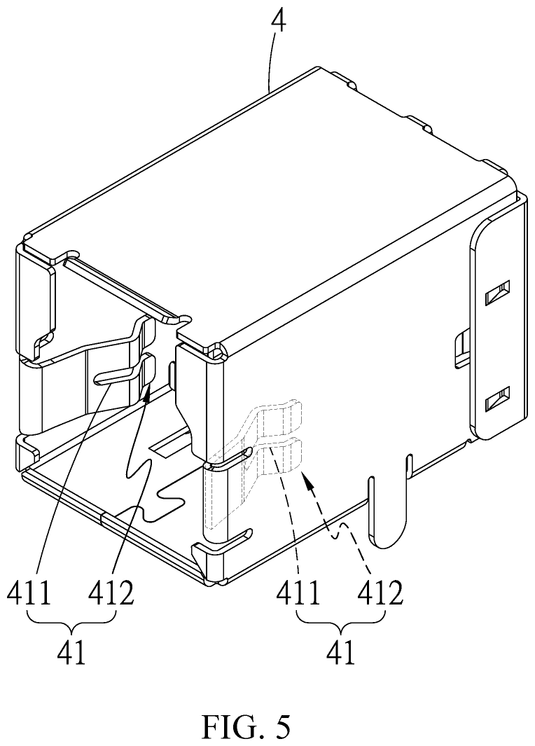

Referring to FIG. 5, which is a see-through view showing a shielding housing of a second preferred embodiment according to the present invention, it is clearly seen from the drawing that to more distinguishably demonstrate the feature of the shielding housing 4 according to the instant embodiment, the upper-row transmission conductor group, the lower-row transmission conductor group, and the insulator assembly are specifically made invisible in the drawing, and the upper-row transmission conductor group and the lower-row transmission conductor group are arranged on an insulator assembly, and a shielding housing 4 is arranged on an outside of the insulator assembly, wherein the instant embodiment is different from the previous embodiment in that in the instant embodiment, the shielding housing 4 is provided, on an inner side of each of a left side and a right side thereof, with a first inner-side spring plate 41, and each of the first inner-side spring plates 41 includes at least one inner-side spring plate notch 411, so that each of the first inner-side spring plates 41 is formed into a plurality of inner-side spring plate contact portions 412, and in the instant embodiment, a single one inner-side spring plate notch 411 is taken as an example for illustration to thereby make two inner-side spring plate contact portions 412, meaning the first inner-side spring plate 41, which originally provides one single contact point on the inner side of each of the left side and right side, is now changed into two contact points (which are respectively the two inner-side spring plate contact portions 412) by means of the inner-side spring plate notch 411, so that the contact area is effectively increased to better drain away noises, allowing the noises to be conducted faster to the outside through the shielding housing 4 to effectively improve transmission quality.

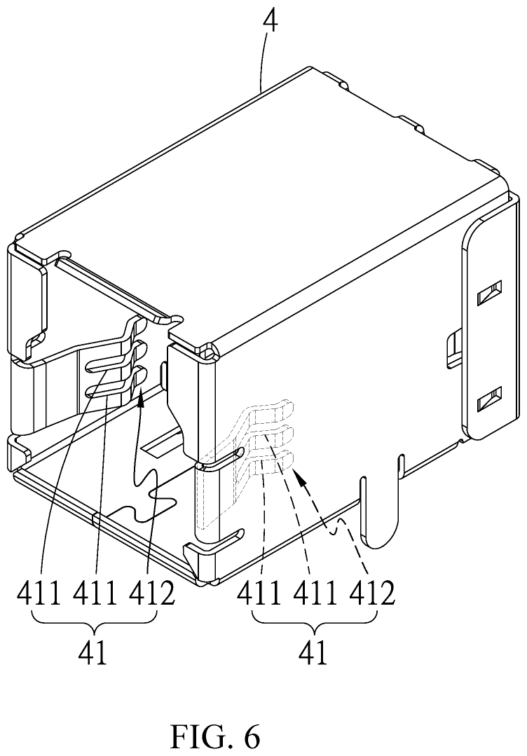

Referring to FIG. 6, which is a see-through view showing a shielding housing of a third preferred embodiment according to the present invention, it is clearly seen from the drawing that to more distinguishably demonstrate the feature of the shielding housing 4 according to the instant embodiment, the upper-row transmission conductor group, the lower-row transmission conductor group, and the insulator assembly are specifically made invisible in the drawing, and the upper-row transmission conductor group and the lower-row transmission conductor group are arranged on an insulator assembly, and a shielding housing 4 is arranged on an outside of the insulator assembly, wherein the shielding housing 4 is provided, on an inner side of each of a left side and a right side thereof, with a first inner-side spring plate 41, and each of the first inner-side spring plates 41 includes at least one inner-side spring plate notch 411, so that each of the first inner-side spring plates 41 is formed into a plurality of inner-side spring plate contact portions 412, wherein the instant embodiment is different from the previous embodiments in that in the instant embodiment, two inner-side spring plate notches 411 are taken as an example for illustration to thereby make three inner-side spring plate contact portions 412, meaning the first inner-side spring plate 41, which originally provides one single contact point on the inner side of each of the left side and right side, is now changed into three contact points (which are respectively the three inner-side spring plate contact portions 412) by means of the two inner-side spring plate notches 411, so that the contact area is effectively increased to better drain away noises, allowing the noises to be conducted faster to the outside through the shielding housing 4 to effectively improve transmission quality.

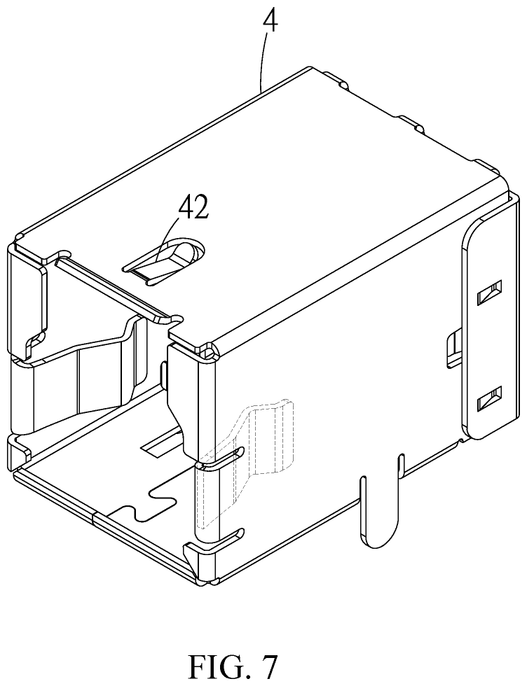

Referring to FIG. 7, which is a see-through view showing a shielding housing of a fourth preferred embodiment according to the present invention, it is clearly seen from the drawing that to more distinguishably demonstrate the feature of the shielding housing 4 according to the instant embodiment, the upper-row transmission conductor group, the lower-row transmission conductor group, and the insulator assembly are specifically made invisible in the drawing, and the upper-row transmission conductor group and the lower-row transmission conductor group are arranged on an insulator assembly, and a shielding housing 4 is arranged on an outside of the insulator assembly, wherein the instant embodiment is different from the previous embodiments in that in the instant embodiment, the shielding housing 4 is provided, on an upper side thereof, with at least one second inner-side spring plate 42, wherein the second inner-side spring plate 42, of which a single one is taken as an example in the instant embodiment, can effectively increase the contact area to better drain away noises, allowing the noises to be conducted faster to the outside through the shielding housing 4 to effectively improve transmission quality.

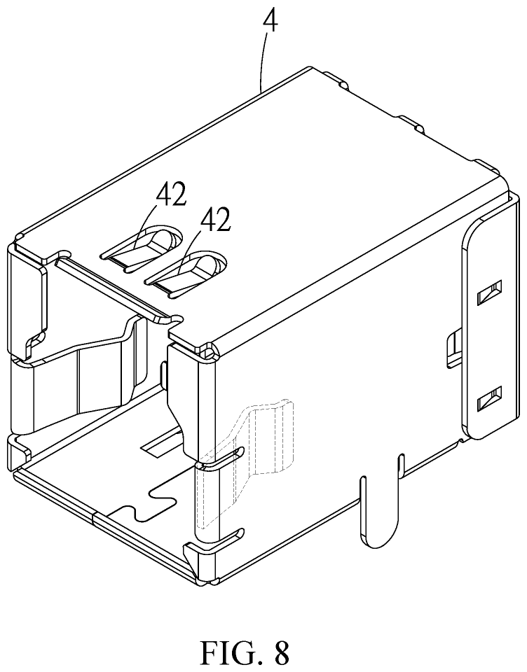

Referring to FIG. 8, which is a see-through view showing a shielding housing of a fifth preferred embodiment according to the present invention, it is clearly seen from the drawing that to more distinguishably demonstrate the feature of the shielding housing 4 according to the instant embodiment, the upper-row transmission conductor group, the lower-row transmission conductor group, and the insulator assembly are specifically made invisible in the drawing, and the upper-row transmission conductor group and the lower-row transmission conductor group are arranged on an insulator assembly, and a shielding housing 4 is arranged on an outside of the insulator assembly, and the shielding housing 4 is provided, on an upper side thereof, with at least one second inner-side spring plate 42, wherein the instant embodiment is different from the previous embodiments in that in the instant embodiment, two second inner-side spring plates 42 are taken as an example for illustration, and compared to the previously described fourth embodiment, the contact area can be more increased to better drain away noises, allowing the noises to be conducted faster to the outside through the shielding housing 4 to effectively improve transmission quality.

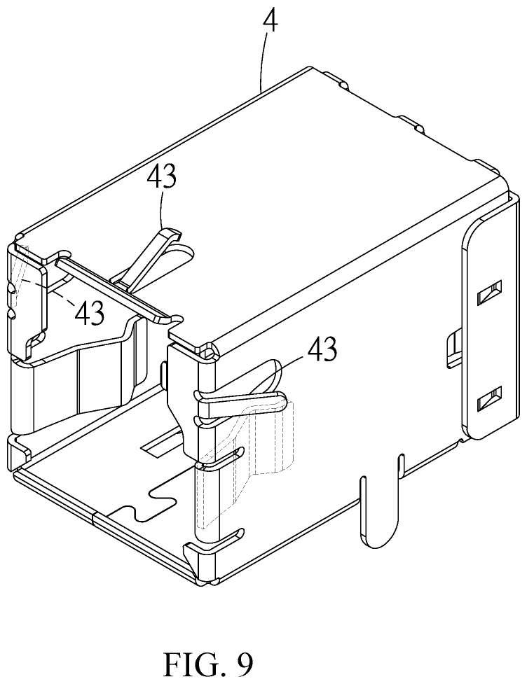

Referring to FIG. 9, which is a see-through view showing a shielding housing of a sixth preferred embodiment according to the present invention, it is clearly seen from the drawing that to more distinguishably demonstrate the feature of the shielding housing 4 according to the instant embodiment, the upper-row transmission conductor group, the lower-row transmission conductor group, and the insulator assembly are specifically made invisible in the drawing, and the upper-row transmission conductor group and the lower-row transmission conductor group are arranged on an insulator assembly, and a shielding housing 4 is arranged on an outside of the insulator assembly, wherein the instant embodiment is different from the previous embodiments in that in the instant embodiment, the shielding housing 4 is provided, on an outer side thereof, with a plurality of contact spring plates 43, and as an example of illustration in the instant embodiment, the shielding housing 4 is provided with a single one contact spring plate 43 on an upper side thereof and one on each of left and right sides thereof, so that contact with an external mechanism can be fulfilled with the contact spring plates 43 to better drain away noises, allowing the noises to be conducted faster to the outside through the shielding housing 4 to effectively improve transmission quality.

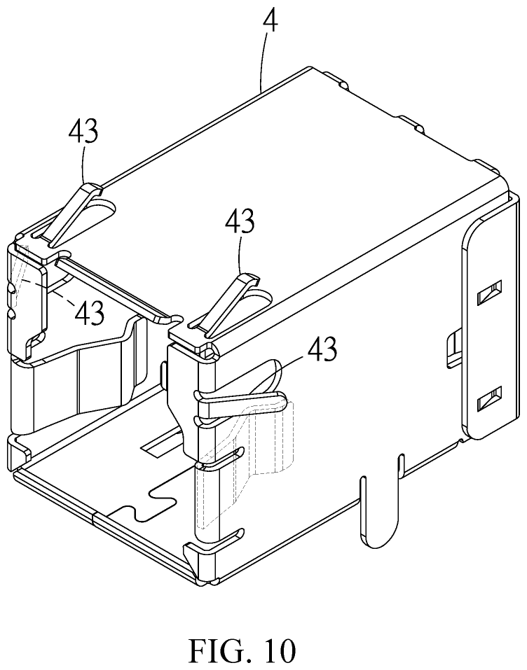

Referring to FIG. 10, which is a see-through view showing a shielding housing of a seventh preferred embodiment according to the present invention, it is clearly seen from the drawing that to more distinguishably demonstrate the feature of the shielding housing 4 according to the instant embodiment, the upper-row transmission conductor group, the lower-row transmission conductor group, and the insulator assembly are specifically made invisible in the drawing, and the upper-row transmission conductor group and the lower-row transmission conductor group are arranged on an insulator assembly, and a shielding housing 4 is arranged on an outside of the insulator assembly, and the shielding housing 4 is provided, on an outer side thereof, with a plurality of contact spring plates 43, wherein the instant embodiment is different from the previous embodiments in that in the instant embodiment, as an example of illustration, the shielding housing 4 is provided with two contact spring plate 43 on an upper side thereof and one on each of left and right sides thereof, so that contact with an external mechanism can be fulfilled with the contact spring plates 43 to better drain away noises, allowing the noises to be conducted faster to the outside through the shielding housing 4 to effectively improve transmission quality.

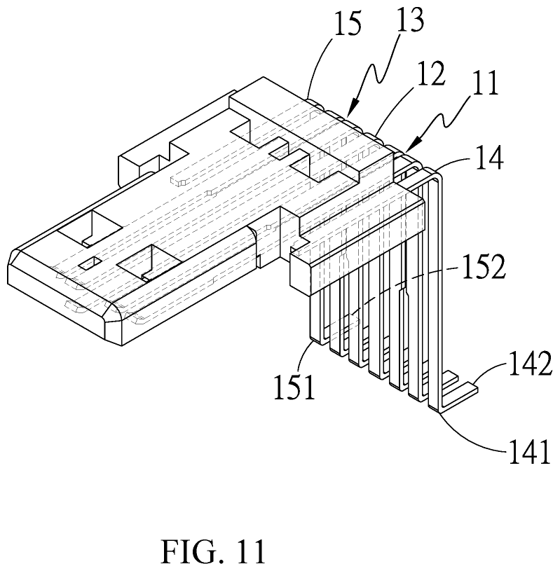

Referring to FIG. 11, which is a perspective see-through view showing an upper-row transmission conductor group of an eighth embodiment according to the present invention, it is clearly seen from the drawing that the instant embodiment is different from the previous embodiments in that in the instant embodiment, an upper-row first grounding transmission conductor 14 is arranged at one side of the upper-row first high-frequency transmission conductor group 11 that is opposite to the upper-row central grounding transmission conductor 12, and an upper-row second grounding transmission conductor 15 is arranged at one side of the upper-row second high-frequency transmission conductor group 13 that is opposite to the upper-row central grounding transmission conductor 12, and the upper-row first grounding transmission conductor 14 includes, at one end thereof, an upper-row first grounding transmission conductor bend portion 141, the upper-row first grounding transmission conductor bend portion 141 being extended to form a surface-mount technology (SMT) type upper-row first grounding transmission conductor soldering portion 142, and the upper-row second grounding transmission conductor 15 includes, at one end thereof, an upper-row second grounding transmission conductor bend portion 151, the upper-row second grounding transmission conductor bend portion 151 being extended to form a surface-mount technology (SMT) type upper-row second grounding transmission conductor soldering portion 152, so that in case of being put into insertion and connection with a counterpart connector for conducting, the upper-row first high-frequency transmission conductor group 11 and the upper-row second high-frequency transmission conductor group 13 generate very high noises during operation thereof, and the noises generated by the upper-row first high-frequency transmission conductor group 11 and the upper-row second high-frequency transmission conductor group 13 can be isolated by the upper-row first grounding transmission conductor 14, the upper-row central grounding transmission conductor 12, and the upper-row second grounding transmission conductor 15, meaning noise interference induced by the upper-row first high-frequency transmission conductor group 11 can be isolated by the upper-row first grounding transmission conductor 14 and the upper-row central grounding transmission conductor 12, and noise interference induced by the upper-row second high-frequency transmission conductor group 13 can be isolated by the upper-row central grounding transmission conductor 12 and the upper-row second grounding transmission conductor 15, and as such, by means of the isolating arrangement of the upper-row first grounding transmission conductor 14, the upper-row central grounding transmission conductor 12, and the upper-row second grounding transmission conductor 15, a stable zero-potential reference point can be provided for signal voltages so as to effectively suppress noise interference, achieving stabilization of transmission quality, reduction of crosstalk interference, and bettering of high frequency. Further, the upper-row first grounding transmission conductor 14 and the upper-row second grounding transmission conductor 15 are respectively provided with surface-mount technology (SMT) type upper-row first grounding transmission conductor soldering portion 142 and upper-row second grounding transmission conductor soldering portion 152 so as to similarly make the manufacturing simple and to further improve the transmission quality.

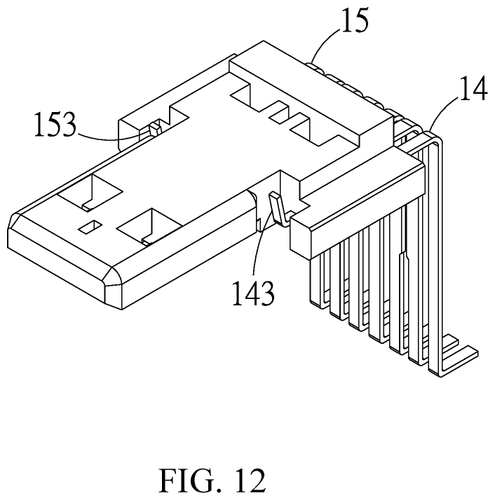

Referring to FIG. 12, which is a perspective view showing an upper-row transmission conductor group of a ninth embodiment according to the present invention, it is clearly seen from the drawing that the instant embodiment is different from the previous embodiments in that in the instant embodiment, the upper-row first grounding transmission conductor 14 includes at least one upper-row first grounding transmission conductor contact portion 143, and the upper-row second grounding transmission conductor 15 includes at least one upper-row second grounding transmission conductor contact portion 153, and in the instant embodiment, the upper-row first grounding transmission conductor contact portion 143 and the upper-row second grounding transmission conductor contact portion 153 are both located at front ends of the upper-row first grounding transmission conductor 14 and the upper-row second grounding transmission conductor 15 to be contactable by a shielding housing of a counterpart connector to form a complete grounding circuit, allowing noises to be drained away faster to improve the quality of transmission of high frequency signals.

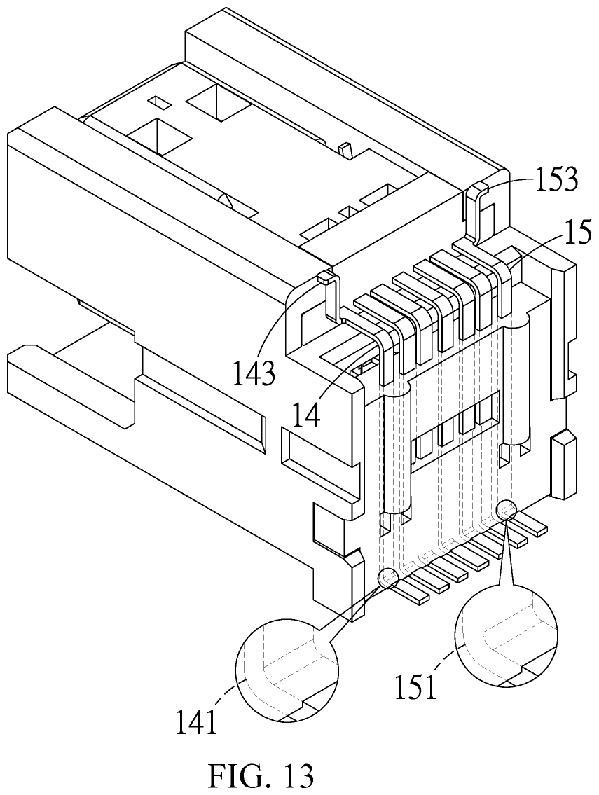

Referring to FIG. 13, which is a perspective see-through view showing an upper-row transmission conductor group of a tenth embodiment according to the present invention, it is clearly seen from the drawing that the upper-row first grounding transmission conductor 14 includes at least one upper-row first grounding transmission conductor contact portion 143, and the upper-row second grounding transmission conductor 15 includes at least one upper-row second grounding transmission conductor contact portion 153, wherein the instant embodiment is different from the previous embodiments in that in the instant embodiment, the upper-row first grounding transmission conductor contact portion 143 is located between a front end of the upper-row first grounding transmission conductor 14 and the upper-row first grounding transmission conductor bend portion 141 and the upper-row second grounding transmission conductor contact portion 153 is located between a front end of the upper-row second grounding transmission conductor 15 and the upper-row second grounding transmission conductor bend portion 151, both being arranged, as an example for illustration, in the form of being extended upward so as to fully contact an inner side surface of the shielding housing to form a complete grounding circuit, allowing noises to be drained away faster to improve the quality of transmission of high frequency signals.

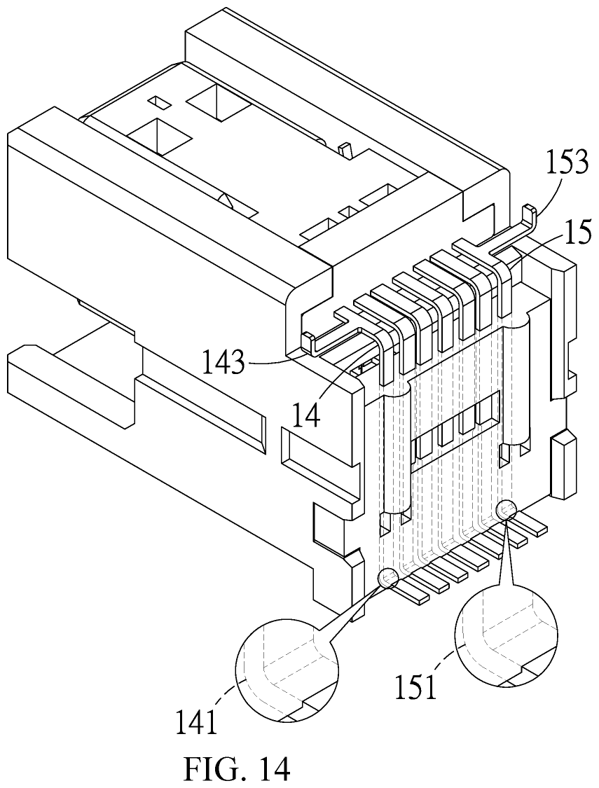

Referring to FIG. 14, which is a perspective see-through view showing an upper-row transmission conductor group of an eleventh embodiment according to the present invention, it is clearly seen from the drawing that the upper-row first grounding transmission conductor 14 includes at least one upper-row first grounding transmission conductor contact portion 143, and the upper-row second grounding transmission conductor 15 includes at least one upper-row second grounding transmission conductor contact portion 153, and the upper-row first grounding transmission conductor contact portion 143 is located between a front end of the upper-row first grounding transmission conductor 14 and the upper-row first grounding transmission conductor bend portion 141, and the upper-row second grounding transmission conductor contact portion 153 is located between a front end of the upper-row second grounding transmission conductor 15 and the upper-row second grounding transmission conductor bend portion 151, wherein the instant embodiment is different from the previous embodiments in that in the instant embodiment, as an example for illustration, the arrangement is made so as to extend horizontally toward two sides so as to fully contact an inner side surface of the shielding housing to form a complete grounding circuit, allowing noises to be drained away faster to improve the quality of transmission of high frequency signals.

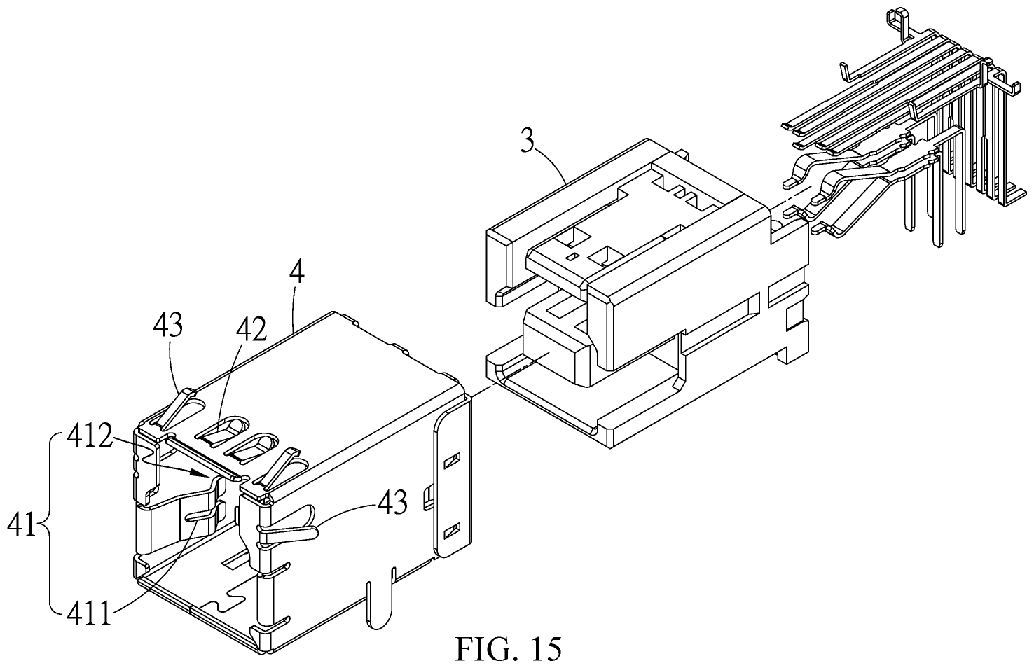

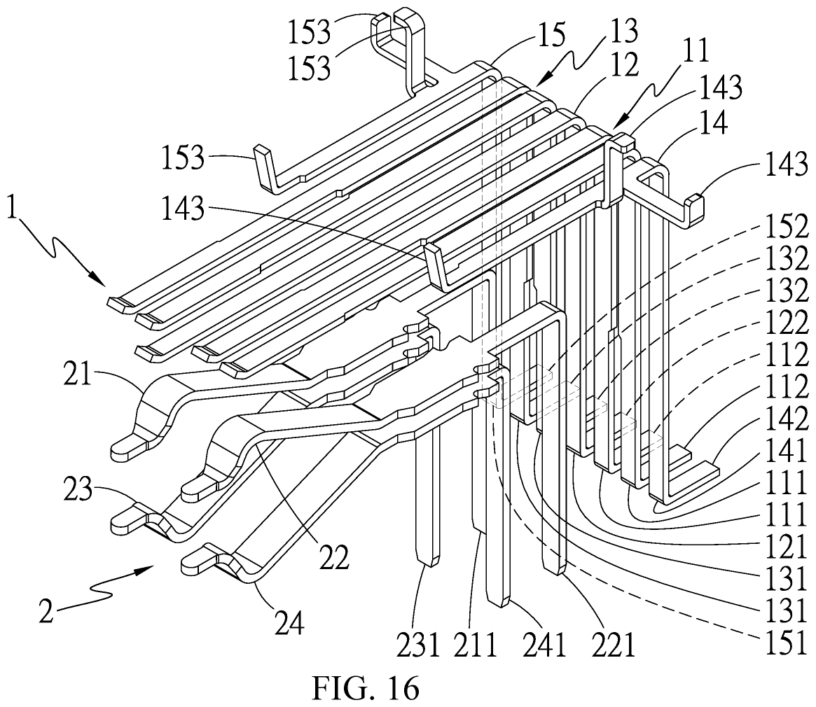

Referring to FIGS. 15 and 16, which are respectively an exploded view of the twelfth preferred embodiment according to the present invention and a perspective see-through view of upper-row and lower-row transmission conductor assemblies thereof, mainly comprises:
an upper-row transmission conductor group 1, which comprises:
an upper-row first high-frequency transmission conductor group 11, which includes, at one end thereof, an upper-row first high-frequency transmission conductor group bend portion 111, the upper-row first high-frequency transmission conductor group bend portion 111 being extended to form a surface-mount technology (SMT) type upper-row first high-frequency transmission conductor group soldering portion 112;
an upper-row central grounding transmission conductor 12, which is arranged at one side of the upper-row first high-frequency transmission conductor group 11 and includes, at one end thereof, an upper-row central grounding transmission conductor bend portion 121, the upper-row central grounding transmission conductor bend portion 121 being extended to form a surface-mount technology (SMT) type upper-row central grounding transmission conductor soldering portion 122; and
an upper-row second high-frequency transmission conductor group 13, which is arranged at one side of the upper-row central grounding transmission conductor 12 opposite to the upper-row first high-frequency transmission conductor group 11 and includes, at one end thereof, an upper-row second high-frequency transmission conductor group bend portion 131, the upper-row second high-frequency transmission conductor group bend portion 131 being extended to form a surface-mount technology (SMT) type upper-row second high-frequency transmission conductor group soldering portion 132; and
a lower-row transmission conductor group 2, which is arranged below the upper-row transmission conductor group 1 and comprises:
a lower-row first signal transmission conductor 21, which includes, at one end thereof, a dual in-line package (DIP) type lower-row first signal transmission conductor soldering portion 211;
a lower-row power transmission conductor 22, which is arranged at one side of the lower-row first signal transmission conductor 21 and includes, at one end thereof, a dual in-line package (DIP) type lower-row power transmission conductor soldering portion 221;
a lower-row second signal transmission conductor 23, which is arranged below the lower-row first signal transmission conductor 21 and includes, at one end thereof, a dual in-line package (DIP) type lower-row second signal transmission conductor soldering portion 231; and
a lower-row grounding transmission conductor 24, which is arranged at one side of the lower-row second signal transmission conductor 23 and below the lower-row power transmission conductor 22 and includes, at one end thereof, a dual in-line package (DIP) type lower-row grounding transmission conductor soldering portion 241.

In the above, an upper-row first grounding transmission conductor 14 is arranged at one side of the upper-row first high-frequency transmission conductor group 11 that is opposite to the upper-row central grounding transmission conductor 12, and an upper-row second grounding transmission conductor 15 is arranged at one side of the upper-row second high-frequency transmission conductor group 13 that is opposite to the upper-row central grounding transmission conductor 12.

In the above, the upper-row first grounding transmission conductor 14 includes, at one end thereof, an upper-row first grounding transmission conductor bend portion 141, the upper-row first grounding transmission conductor bend portion 141 being extended to form a surface-mount technology (SMT) type upper-row first grounding transmission conductor soldering portion 142, and the upper-row second grounding transmission conductor 15 includes, at one end thereof, an upper-row second grounding transmission conductor bend portion 151, the upper-row second grounding transmission conductor bend portion 151 being extended to form a surface-mount technology (SMT) type upper-row second grounding transmission conductor soldering portion 152.

In the above, the upper-row first grounding transmission conductor 14 includes at least one upper-row first grounding transmission conductor contact portion 143, and the upper-row second grounding transmission conductor 15 includes at least one upper-row second grounding transmission conductor contact portion 153.

In the above, the upper-row first grounding transmission conductor contact portion 143 and the upper-row second grounding transmission conductor contact portion 153 are respectively located at front ends of the upper-row first grounding transmission conductor 14 and the upper-row second grounding transmission conductor 15, and located between the front end of the upper-row first grounding transmission conductor 14 and the upper-row first grounding transmission conductor bend portion 141, and located between the front end of the upper-row second grounding transmission conductor 15 and the upper-row second grounding transmission conductor bend portion 151.

In the above, the upper-row transmission conductor group 1 and the lower-row transmission conductor group 2 are arranged on an insulator assembly 3, and a shielding housing 4 is arranged on an outside of the insulator assembly 3, and the shielding housing 4 is provided, on an inner side of each of a left side and a right side thereof, with a first inner-side spring plate 41, and each of the first inner-side spring plates 41 includes at least one inner-side spring plate notch 411, so that each of the first inner-side spring plates 41 is formed into a plurality of inner-side spring plate contact portions 412, and further, the shielding housing 4 is provided, on an upper side thereof, with at least one second inner-side spring plate 42, and further, the shielding housing 4 is provided, on an outer side thereof, with a plurality of contact spring plates 43.

As such, when the signal connector according to the present invention is made conducting for being put into operation, noises generated by the upper-row first high-frequency transmission conductor group 11 and the upper-row second high-frequency transmission conductor group 13 are isolated by the upper-row first grounding transmission conductor 14, the upper-row central grounding transmission conductor 12, and the upper-row second grounding transmission conductor 15, so as to effectively suppress electromagnetic interference (EMI), radio frequency interference (RFI), and crosstalk interference, making transmission of high-frequency signals through the upper-row first high-frequency transmission conductor group 11 and the upper-row second high-frequency transmission conductor group 13 more stable.

Further, compared to the previously described embodiments, the instant embodiment includes more noise draining paths, which, in addition to the originally provided upper-row first grounding transmission conductor 14, upper-row central grounding transmission conductor 12, and upper-row second grounding transmission conductor 15, further includes a plurality of upper-row first grounding transmission conductor contact portions 143 and a plurality of upper-row second grounding transmission conductor contact portions 153, and the upper-row first grounding transmission conductor contact portions 143 are respectively set at three locations, which are a location at a front end of the upper-row first grounding transmission conductor 14, a location between the front end of the upper-row first grounding transmission conductor 14 and the upper-row first grounding transmission conductor bend portion 141 in the form of being bent upward, and a location between the front end of the upper-row first grounding transmission conductor 14 and the upper-row first grounding transmission conductor bend portion 141 in the form of being bent horizontally sideways, and the upper-row second grounding transmission conductor contact portions 153 are respectively set at three locations, which are a location at a front end of the upper-row second grounding transmission conductor 15, a location between the front end of the upper-row second grounding transmission conductor 15 and the upper-row second grounding transmission conductor bend portion 151 in the form of being bent upwards, and a location between the front end of the upper-row second grounding transmission conductor 15 and the upper-row second grounding transmission conductor bend portion 151 in the form of being bent horizontally sideways, so that the upper-row first grounding transmission conductor 14 can drain away noises in a faster way through the above-mentioned three locations, and similarly, the upper-row second grounding transmission conductor 15 can drain away noises in a faster way through the above-mentioned three locations, making an overall effect of noise draining better for fast stabilizing signal transmission quality.

While various embodiments of the present invention have been shown and described in the disclosure, such embodiments are provided by way of example only, and any theory of operation or benefit provided herein is intended only as an aid in illustrating the present invention. The theory and explanation do not bind or limit the scope of the claims with respect to combination rearrangement achieved by practicing the present invention. Those skilled in the art can now devise many variations, changes, or substitutions without departing from the present invention. It should be understood that various alternatives to the embodiments of the present invention described herein may be employed in practicing the present invention. Equivalents are intended to be included within the scope of the present invention, and methods and structures within the scope of the invention.

To sum up, the structure of signal connector according to the present invention can indeed achieve its effect and purpose when used. Therefore, the present invention is an invention with excellent practicality and meets the application requirements for an invention patent. A patent application is thus filed accordingly, and early granting a patent is earnestly solicited.

I claim:

1. A structure of signal connector, mainly comprising:
an upper-row transmission conductor group, which comprises an upper-row first high-frequency transmission conductor group, which includes, at one end thereof, an upper-row first high-frequency transmission conductor group bend portion, the upper-row first high-frequency transmission conductor group bend portion being extended to form a surface-mount technology (SMT) type upper-row first high-frequency transmission conductor group soldering portion; an upper-row central grounding transmission conductor, which is arranged at one side of the upper-row first high-frequency transmission conductor group and includes, at one end thereof, an upper-row central grounding transmission conductor bend portion, the upper-row central grounding transmission conductor bend portion being extended to form a surface-mount technology (SMT) type upper-row central grounding transmission conductor soldering portion; and an upper-row second high-frequency transmission conductor group, which is arranged at one side of the upper-row central grounding transmission conductor that is opposite to the upper-row first high-frequency transmission conductor group and includes, at one end thereof, an upper-row second high-frequency transmission conductor group bend portion, the upper-row second high-frequency transmission conductor group bend portion being extended to form a surface-mount technology (SMT) type upper-row second high-frequency transmission conductor group soldering portion; and
a lower-row transmission conductor group, which is arranged below the upper-row transmission conductor group and comprises a lower-row first signal transmission conductor, which includes, at one end thereof, a dual in-line package (DIP) type lower-row first signal transmission conductor soldering portion; a lower-row power transmission conductor, which is arranged at one side of the lower-row first signal transmission conductor and includes, at one end thereof, a dual in-line package (DIP) type lower-row power transmission conductor soldering portion; a lower-row second signal transmission conductor, which is arranged below the lower-row first signal transmission conductor and includes, at one end thereof, a dual in-line package (DIP) type lower-row second signal transmission conductor soldering portion, and a lower-row grounding transmission conductor, which is arranged at one side of the lower-row second signal transmission conductor and below the lower-row power transmission conductor and includes, at one end thereof, a dual in-line package (DIP) type lower-row grounding transmission conductor soldering portion.

2. The structure of signal connector according to claim 1, wherein an upper-row first grounding transmission conductor is arranged at one side of the upper-row first high-frequency transmission conductor group that is opposite to the upper-row central grounding transmission conductor, and an upper-row second grounding transmission conductor is arranged at one side of the upper-row second high-frequency transmission conductor group that is opposite to the upper-row central grounding transmission conductor.

3. The structure of signal connector according to claim 2, wherein the upper-row first grounding transmission conductor includes, at one end thereof, an upper-row first grounding transmission conductor bend portion, the upper-row first grounding transmission conductor bend portion being extended to form a surface-mount technology (SMT) type upper-row first grounding transmission conductor soldering portion, and the upper-row second grounding transmission conductor includes, at one end thereof, an upper-row second grounding transmission conductor bend portion, the upper-row second grounding transmission conductor bend portion being extended to form a surface-mount technology (SMT) type upper-row second grounding transmission conductor soldering portion.

4. The structure of signal connector according to claim 3, wherein the upper-row first grounding transmission conductor includes at least one upper-row first grounding transmission conductor contact portion, and the upper-row second grounding transmission conductor includes at least one upper-row second grounding transmission conductor contact portion.

5. The structure of signal connector according to claim 4, wherein the upper-row first grounding transmission conductor contact portion and the upper-row second grounding transmission conductor contact portion are respectively located at front ends of the upper-row first grounding transmission conductor and the upper-row second grounding transmission conductor.

6. The structure of signal connector according to claim 4, wherein the upper-row first grounding transmission conductor contact portion is located between a front end of the upper-row first grounding transmission conductor and the upper-row first grounding transmission conductor bend portion, and the upper-row second grounding transmission conductor contact portion is located between a front end of the upper-row second grounding transmission conductor and the upper-row second grounding transmission conductor bend portion.

7. The structure of signal connector according to claim 1, wherein the upper-row transmission conductor group and the lower-row transmission conductor group are arranged on an insulator assembly, and a shielding housing is arranged on an outside of the insulator assembly, and wherein the shielding housing is provided, on an inner side of each of a left side and a right side thereof, with a first inner-side spring plate, and each of the first inner-side spring plates includes at least one inner-side spring plate notch, so that each of the first inner-side spring plates is formed into a plurality of inner-side spring plate contact portions.

8. The structure of signal connector according to claim 2, wherein the upper-row transmission conductor group and the lower-row transmission conductor group are arranged on an insulator assembly, and a shielding housing is arranged on an outside of the insulator assembly, and wherein the shielding housing is provided, on an inner side of each of a left side and a right side thereof, with a first inner-side spring plate, and each of the first inner-side spring plates includes at least one inner-side spring plate notch, so that each of the first inner-side spring plates is formed into a plurality of inner-side spring plate contact portions.

9. The structure of signal connector according to claim 1, wherein the upper-row transmission conductor group and the lower-row transmission conductor group are arranged on an insulator assembly, and a shielding housing is arranged on an outside of the insulator assembly, and wherein the shielding housing is provided, on an upper side thereof, with at least one second inner-side spring plate.

10. The structure of signal connector according to claim 2, wherein the upper-row transmission conductor group and the lower-row transmission conductor group are arranged on an insulator assembly, and a shielding housing is arranged on an outside of the insulator assembly, and wherein the shielding housing is provided, on an upper side thereof, with at least one second inner-side spring plate.

11. The structure of signal connector according to claim 1, wherein the upper-row transmission conductor group and the lower-row transmission conductor group are arranged on an insulator assembly, and a shielding housing is arranged on an outside of the insulator assembly, and wherein the shielding housing is provided, on an outer side thereof, with a plurality of contact spring plates.

12. The structure of signal connector according to claim 2, wherein the upper-row transmission conductor group and the lower-row transmission conductor group are arranged on an insulator assembly, and a shielding housing is arranged on an outside of the insulator assembly, and wherein the shielding housing is provided, on an outer side thereof, with a plurality of contact spring plates.
